(19) United States
(12) Patent Application Publication
(10) Pub. No.: US 2024/0007162 A1
(43) Pub. Date: Jan. 4, 2024

(54) CHANNEL STATE INFORMATION (CSI) REFERENCE SIGNAL (RS) (CSI-RS) REPETITION CONFIGURATIONS FOR HIGH DOPPLER SYSTEMS

(71) Applicant: QUALCOMM Incorporated, San Diego, CA (US)

(72) Inventors: Qiaoyu LI, Beijing (CN); Yu ZHANG, San Diego, CA (US); Hao XU, Beijing (CN); Liangming WU, Beijing (CN); Chenxi HAO, Beijing (CN); Chao WEI, Beijing (CN)

(21) Appl. No.: 17/997,705

(22) PCT Filed: Jun. 30, 2022
(86) PCT No.: PCT/CN2020/099385

§ 371 Date: Nov. 1, 2022

(51) Int. Cl. H04B 7/06; H04L 5/00

(52) U.S. Cl. CPC H04B 7/0626; H04B 7/06968; H04L 5/0023; H04L 5/0048

(57) ABSTRACT

Aspects of the present disclosure relate to wireless communications, and more particularly, to techniques for configuring CSI-RS repetitions for CSI measurement in high Doppler scenarios. An example method generally includes receiving, from a network entity, a configuration identifying channel state information (CSI) reference signal (RS) (CSI-RS) repetitions over which a CSI report is to be generated, receiving CSI-RS repetitions according to the configuration, measuring CSI based on the received CSI-RS repetitions, and transmitting the CSI report including the measured CSI to the network entity.

### TECHNICAL FIELD

Aspects of the present disclosure relate to wireless communications, and more particularly, to techniques for configuring channel state information (CSI) reference signal (RS) (CSI-RS) repetitions for measurement in high Doppler systems.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (for example, bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (for example, 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several innovative aspects, no single one of which is solely responsible for the desirable attributes.

One innovative aspect of the subject matter described in this disclosure can be implemented in a method for wireless communication by a user equipment (UE). The method generally includes receiving, from a network entity, a configuration identifying channel state information (CSI) reference signal (RS) (CSI-RS) repetitions over which a CSI report is to be generated, receiving CSI-RS repetitions according to the configuration, measuring CSI based on the received CSI-RS repetitions, and transmitting the CSI report including the measured CSI to the network entity.

One innovative aspect of the subject matter described in this disclosure can be implemented in a method for wireless communication by a network entity. The method generally includes transmitting, to a user equipment (UE), a configuration identifying channel state information (CSI) reference signal (RS) (CSIRS) repetitions over which a CSI report is to be generated, transmitting CSI-RS repetitions according to the configuration, receiving a CSI report from the UE based on the transmitted CSI-RS repetitions, determining one or more parameters for communicating with the UE based on the received CSI report, and transmitting the determined parameters to the UE.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail some illustrative features of the one or more aspects. These features are indicative, however, of but a few of the various ways in which the principles of various aspects may be employed.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows an example wireless communication network in which some aspects of the present disclosure may be performed.

FIG. 2 shows a block diagram illustrating an example base station (BS) and an example user equipment (UE) in accordance with some aspects of the present disclosure.

FIG. 3A illustrates an example of a frame format for a telecommunication system.

FIG. 3B illustrates how different synchronization signal blocks (SSBs) may be sent using different beams.

FIG. 4 illustrates a scenario in which channel state information (CSI) reports become outdated in high Doppler scenarios.

FIG. 5 illustrates example operations for wireless communication by a user equipment (UE), in accordance with some aspects of the present disclosure.

FIG. 6 illustrates example operations for wireless communication by a network entity, in accordance with some aspects of the present disclosure.

FIG. 7 illustrates an example channel state information (CSI) reference signal (RS) (CSI-RS) repetition for measuring CSI in high Doppler scenarios, in accordance with some aspects of the present disclosure.

FIGS. 8A-8C illustrate examples of CSI-RS patterns for CSI-RS resource repetition, in accordance with some aspects of the present disclosure.

FIGS. 9A-9B illustrates example staggered CSI-RS patterns for CSI-RS resource repetition, in accordance with some aspects of the present disclosure.

FIG. 10 illustrates an example CSI-RS repetition in which different CSI-RS repetitions are assumed to use same or different quasi-colocation (QCL) references, in accordance with some aspects of the present disclosure.

FIG. 11 illustrates an example CSI-RS repetition using time domain spreading, in accordance with some aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to mobility techniques that allow for configuring channel state information (CSI) reference signal (RS) (CSI-RS) repetitions for measurement in high Doppler systems.

The following description provides examples of configuring channel state information (CSI) reference signal (RS) (CSI-RS) repetitions for measurement in high Doppler systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

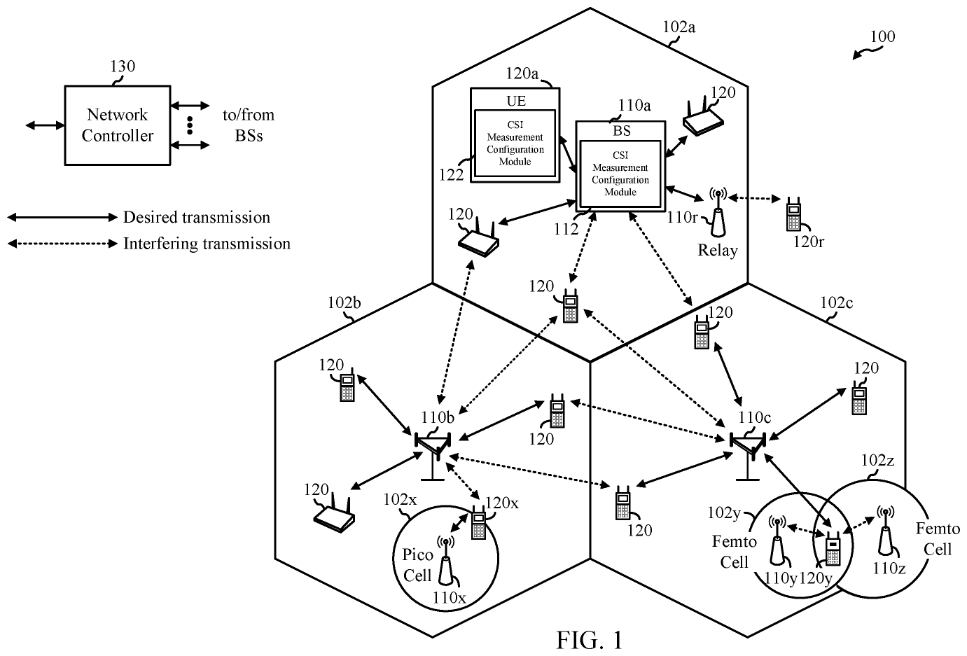

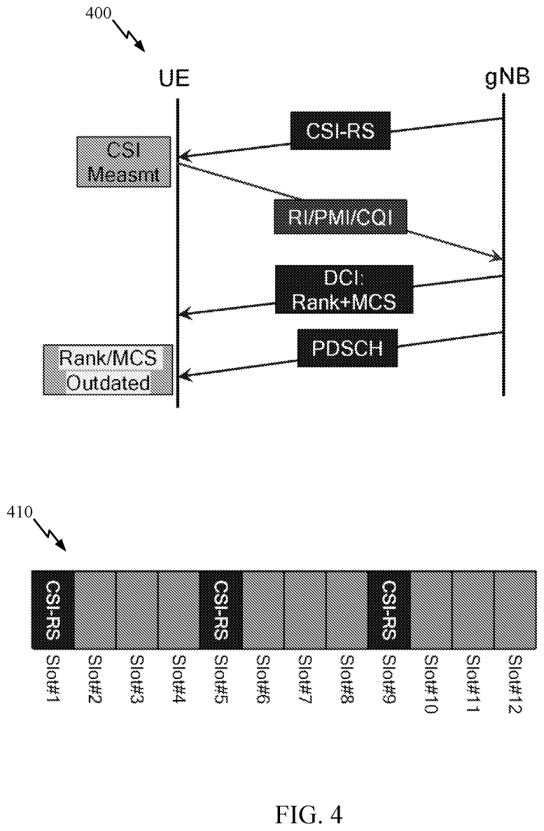

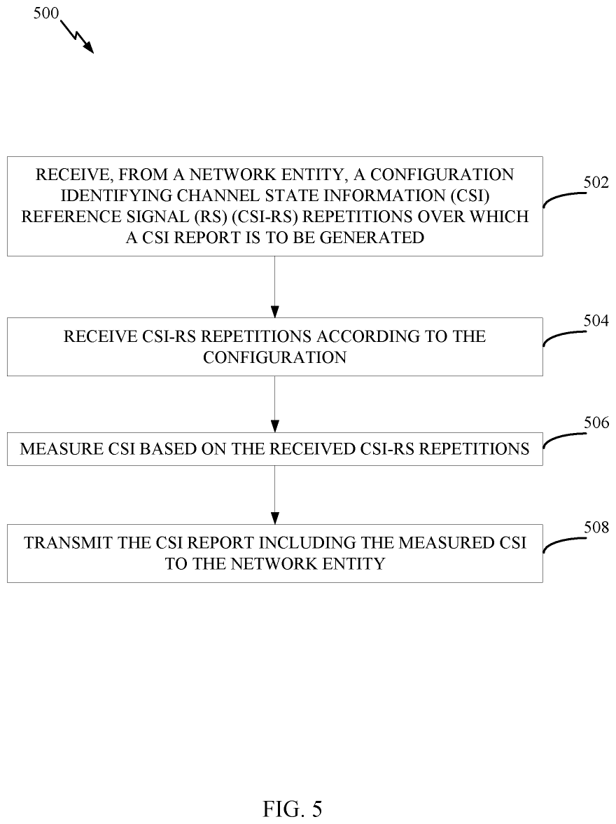

FIG. 1 illustrates an example wireless communication network 100 in which aspects of the present disclosure may be performed. For example, as shown in FIG. 1, UE 120a may include a CSI measurement configuration module 122 that may be configured to perform (or cause UE 120a to perform) operations 500 of FIG. 5. Similarly, a BS 120a may include a CSI measurement configuration module 112 that may be configured to perform (or cause BS 110a to perform) operations 600 of FIG. 6.

NR access (for example, 5G NR) may support various wireless communication services, such as enhanced mobile broadband (eMBB) targeting wide bandwidth (for example, 80 MHz or beyond), millimeter wave (mmWave) targeting high carrier frequency (for example, 25 GHz or beyond), massive machine type communications MTC (mMTC) targeting non-backward compatible MTC techniques, or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same time-domain resource (for example, a slot or subframe) or frequency-domain resource (for example, component carrier).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another or to one or more other BSs or network nodes (not shown) in wireless communication network 100 through various types of backhaul interfaces (for example, a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (for example, 120x, 120y, etc.) may be dispersed throughout the wireless communication network 100, and each UE 120 may be stationary or mobile.

Wireless communication network 100 may also include relay stations (for example, relay station 110r), also referred to as relays or the like, that receive a transmission of data or other information from an upstream station (for example, a BS 110a or a UE 120r) and sends a transmission of the data or other information to a downstream station (for example, a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (for example, directly or indirectly) via wireless or wireline backhaul.

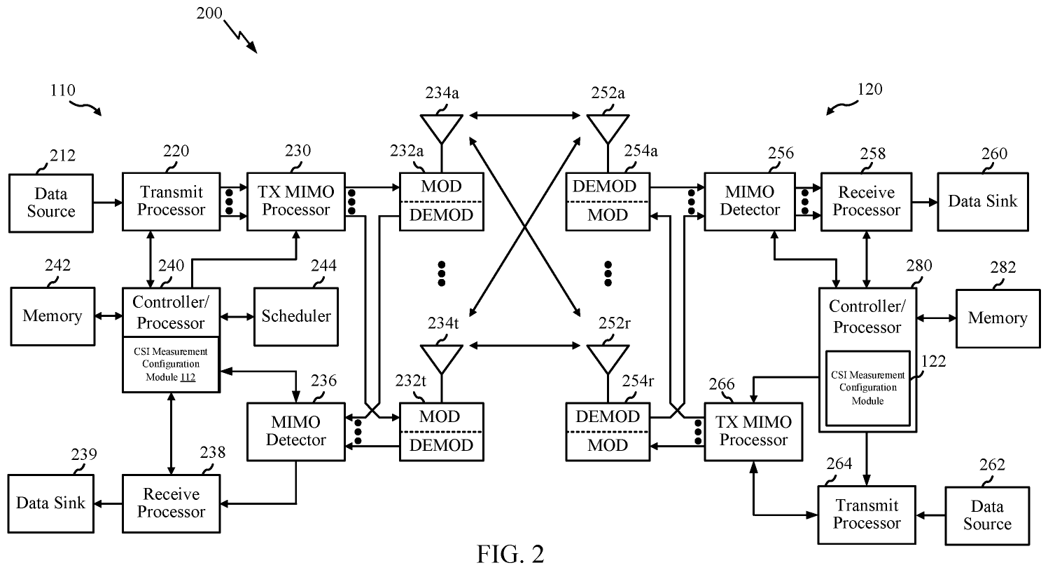

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 or other processors and modules at the UE 120 may perform or direct the execution of processes for the techniques described herein. As shown in FIG. 2, the controller/processor 280 of the UE 120 has a CSI measurement configuration module 122 that may be configured to perform (or cause UE 120 to perform) operations 500 of FIG. 5. Similarly, the BS 120a may include a CSI measurement configuration module 112 that may be configured to perform (or cause BS 110a to perform) operations 600 of FIG. 6.

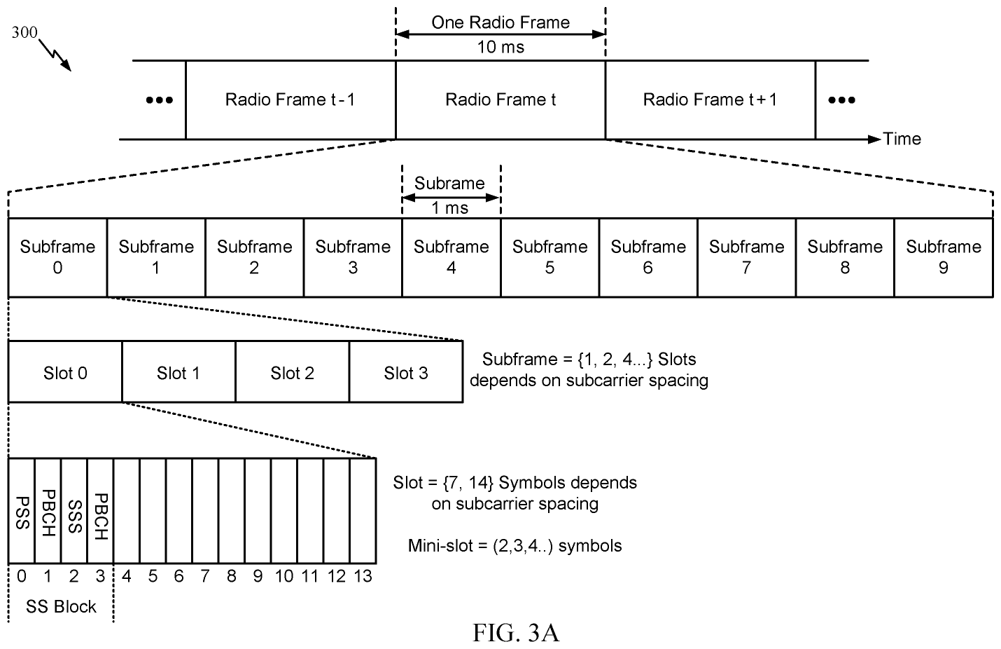

FIG. 3A is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3A. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

As shown in FIG. 3B, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

### Example Methods for Configuring Channel State Measurement (CSI) Reference Signal (RS) (CSI-RS) Repetitions for Measurement in High Doppler Systems

Aspects of the present disclosure relate to wireless communications, and more particularly, to configuring channel state information (CSI) reference signal (RS) (CSI-RS) repetitions for measurement in high Doppler systems. As will be described in greater detail below, CSI-RS repetitions may be configured and transmitted from a network entity to a user equipment (UE) to allow for CSI measurement reports to be generated over a period of time such that the CSI measurement reports and adjustments to communication parameters based on the CSI measurement reports take into account UE movement in high speed/high Doppler environments.

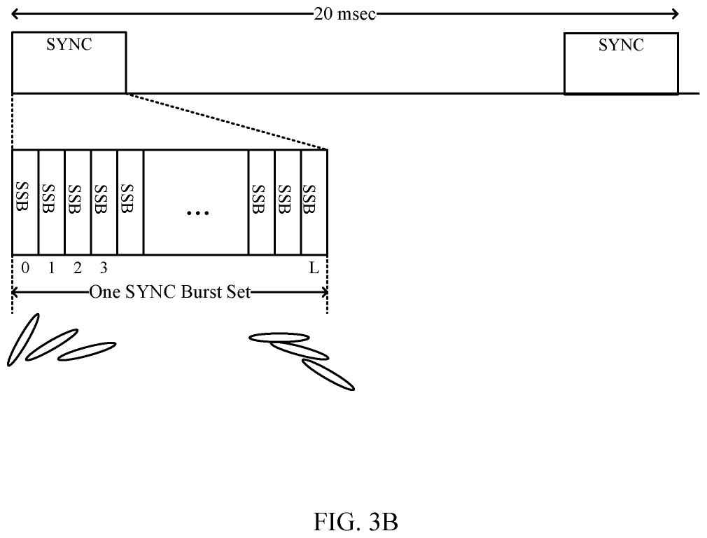

FIG. 4 illustrates an example scenario in which a channel state information (CSI) report becomes outdated in a high Doppler scenario. As illustrated, a network entity may be configured to transmit a CSI-RS periodically according to configuration 410, in which a CSI-RS is transmitted every four slots, which may be a minimum interval for transmitting CSI-RSs to a UE for measurement. For each of these CSI-RSs, as illustrated in timeline 400, a UE may perform a CSI measurement and report CSI (e.g., a rank indicator (RI), precoding matrix indicator (PMI), and/or channel quality indicator (CQI)) to a serving network entity. In response, the serving network entity may transmit a downlink control information (DCI) including transmission parameters for downlink transmissions to the UE, such as a rank and a modulation and coding scheme (MCS). However, by the time the network entity performs a subsequent downlink transmission (e.g., on PDSCH), the rank and/or MCS may be outdated and thus inappropriate for the current channel conditions at the UE.

For aperiodic CSI reports using aperiodic CSI-RS resources, a CSI report may be based on an instantaneous observation of a single CSI resource. In scenarios where a UE is stationary or moving slowly, an instantaneous observation of a single CSI resource may provide sufficiently accurate information regarding the condition of a channel; however, in high Doppler scenarios, the reported CSI (e.g., RI/PMI/CQO) may be inaccurate because the channel may vary rapidly due to the UE being in a high Doppler scenario.

For CSI reports using periodic or semipersistently scheduled CSI-RS resources, a UE can perform time domain filtering over multiple channel observations and report a CQI based on averaged channel observations. However, quasi-colocation (QCL) assumptions may not be defined for different CSI-RS observations, which may make CQI calculation assumptions unclear or uncertain. For example, a UE may not be aware of time domain precoder cycling, which may be introduced for performance gains in high Doppler scenarios, for different CSI-RSs. Further, because CSI-RSs may be transmitted periodically over a number of slots, filtering over multiple channel observations may introduce a delay in capturing time variation in channel conditions.

To account for high Doppler scenarios in measuring CSI, aspects of the present disclosure may provide for various CSI-RS resource repetitions that can be used to allow for accurate measurement of rapidly changing channel conditions in high Doppler scenarios.

FIG. 5 illustrates example operations 500 that may be performed by a user equipment (UE) to report CSI based on a CSI-RS resource repetition configuration for measuring CSI in high Doppler scenarios, according to certain aspects of the present disclosure. Operations 500 may be performed, for example, by a UE 120 illustrated in FIG. 1.

Operations 500 begin, at 502, where the UE receives, from a network entity, a configuration identifying channel state information (CSI) reference signal (RS) (CSI-RS) repetitions over which a CSI report is to be generated.

At 504, the UE receives CSI-RS repetitions according to the configuration.

At 506, the UE measures CSI based on the received CSI-RS repetitions.

At 508, the UE transmits the CSI report including the measured CSI to the network entity.

FIG. 6 illustrates example operations 600 that may considered complementary to operations 500 of FIG. 5. For example, operations 600 may be performed by a network entity (e.g., a gNB DU/CU) to configure a UE (performing operations 500 of FIG. 5) to measure CSI based on a CSI-RS configuration identifying CSI-RS repetitions over which a CSI report is to be generated.

Operations 600 begin, at 602, where the network entity transmits, to a user equipment (UE), a configuration identifying channel state information (CSI) reference signal (RS) (CSI-RS) repetitions over which a CSI report is to be generated.

At 604, the network entity transmits CSI-RS repetitions to the UE according to the configuration.

At 606, the network entity receives a CSI report from the UE based on the transmitted CSI repetitions.

At 608, the network entity determines one or more parameters for communicating with the UE based on the received CSI report and transmits the determined parameters to the UE.

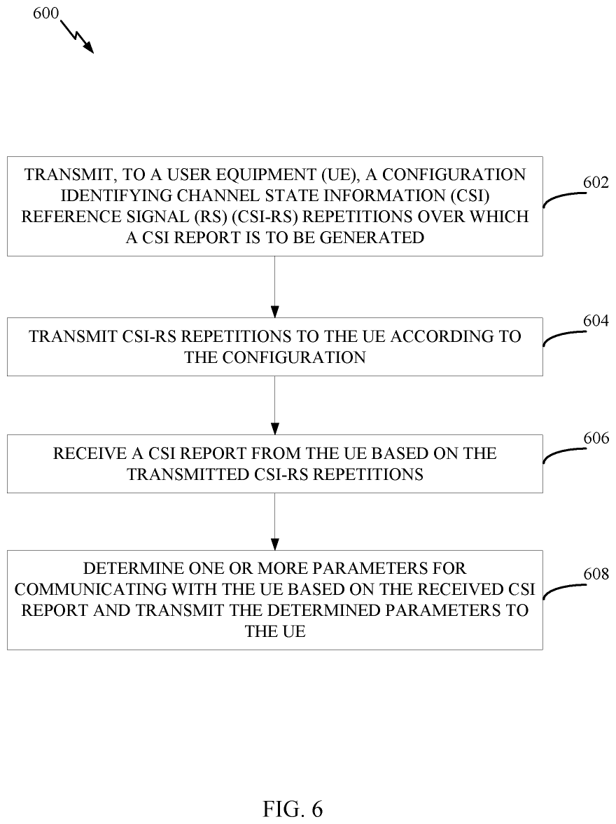

In some embodiments, the CSI-RS repetitions may be defined as an intra-slot or inter-slot repetition over which a CSI measurement is performed (e.g., averaged over time, etc.) and reported to a network entity. FIG. 7 illustrates an example of an intra-slot CSI-RS repetition 700 in which CSI-RS resources are repeated in the time domain. A number of the repeated CSI-RS resources may be used for associated CSI reports, and the CSI reports generated from the CSI-RS repetitions may include one or more of a rank indicator (RI), precoding matrix indicator (PMI), or channel quality indicator (CQI).

Repetition and measurement of CSI-RS repetitions in the time domain may be activated, in some embodiments, if an NZP-CSI-RS-ResourceSet is configured with both the Repetition-On and trs-info parameters enabled (e.g., repetition enabled and tracking reference signal (TRS) information enabled). There may be no restrictions on the CSI-RS patterns (e.g., a number of ports, pattern density, etc.). A UE may assume the same or different QCL references for the different CSI-RS resources. For example, a UE need not assume the same QCL-TypeD reference for each of the CSI-RS resources. The report may include additional information beyond physical layer reference signal received power (L1-RSRP) measurements; for example, as discussed above, the report may include RI, PMI, and/or CQI. In some aspects, if the NZP-CSI-RS-ResourceSet includes periodic CSI-RSs (e.g., includes a periodicity parameter for the CSI-RSs), the NZP-CSI-RS-ResourceSet may be associated with a CSI report configuration, and the CSI report configuration may be configured with a time restriction for channel measurements.

In some aspects, a time domain repetition periodicity may include a one-slot periodicity. CSI-RS repetitions may be configured on an intra-slot or joint inter-slot and intra-slot basis. For example, a CSI-RS repetition configuration may specify that CSI-RSs are repeated n times within a slot, with a periodicity of m slots.

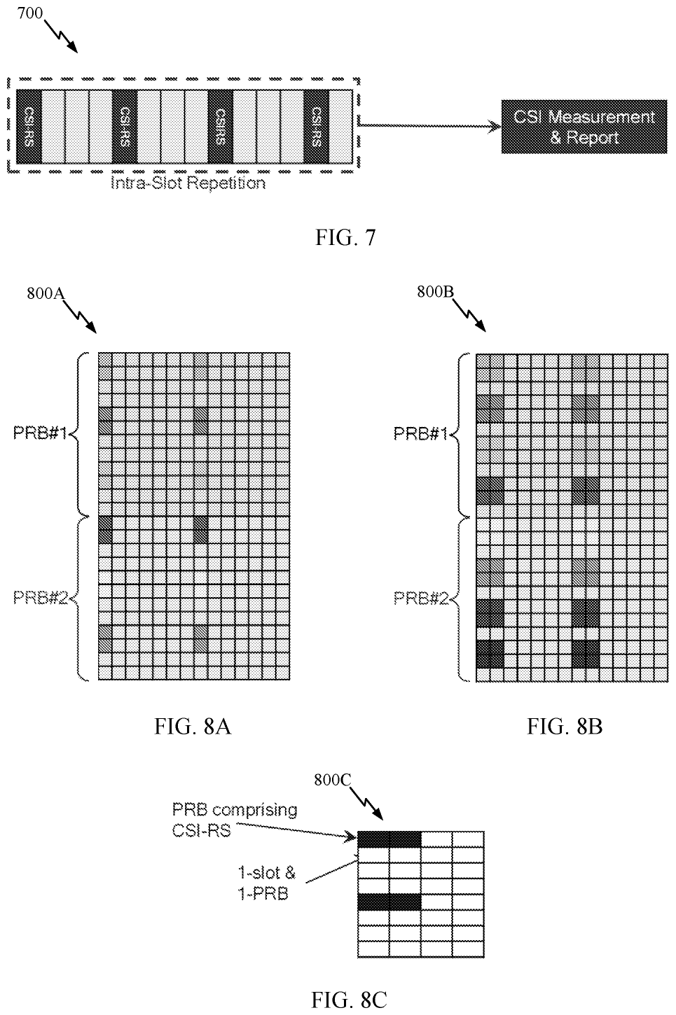

FIGS. 8A-8C illustrate example CSI-RS patterns for CSI-RS resource repetition. Generally, when CSI-RS resource repetition is enabled for CSI reporting, as discussed above, various patterns may be considered with repetition across different physical resource blocks.

FIG. 8A illustrates an example CSI-RS pattern 800A in which a total number of configured CSI-RS ports span multiple PRBs in the frequency domain. In this example, six CSI-RSs may be defined according to different frequency resources for a given time resource. Unlike a configuration in which CSI-RSs are distributed within a single PRB, example CSI-RS pattern 800A may spread CSI-RS resources across different PRBs so that additional frequency intervals may be enabled between adjacent CSI-RS components. The number of interval resource elements may be defined based on a number of CSI-RS resource repetitions.

FIG. 8B illustrates an example CSI-RS pattern 800B in which time domain multiplexed CSI-RS components within a single PRB are frequency multiplexed across different PRBs. For example, in Release 15/Release 16 CSI-RS configurations, a number of CSI-RS resources may be time multiplexed on a same frequency resource (e.g., such that two CSI-RS resources for different CSI-RS ports are adjacent to each other in the time domain and use the same frequency resources). In CSI-RS pattern 800B, CSI-RS resources for different CSI-RS ports may be frequency multiplexed across different PRBs such that each CSI-RS port is associated with a specific, unique set of frequency resources. Further, as illustrated, a plurality of CSI-RS resource repetitions may be defined in the time domain, and each CSI-RS port may use a same frequency resource for each CSI-RS repetition.

FIG. 8C illustrates an example of PRB-level combs for CSI-RS repetitions. In example 800C, a higher number of PRB-level combs (e.g., comb-r or comb-6) may be configured for CSI-RS repetitions based on the number of CSI-RS resource repetitions.

Generally, by frequency division multiplexing CSI-RS resources, the overall CSI-RS density may be minimized when CSI-RS resource repetition is disabled. Further, enabling frequency division multiplexed CSI-RS resource repetition may provide for improvements in measuring CSI in high Doppler scenarios, and in high Doppler scenarios with low or medium delay spread, previously defined time division multiplexed CSI-RS repetitions for different CSI-RS ports may still be used.

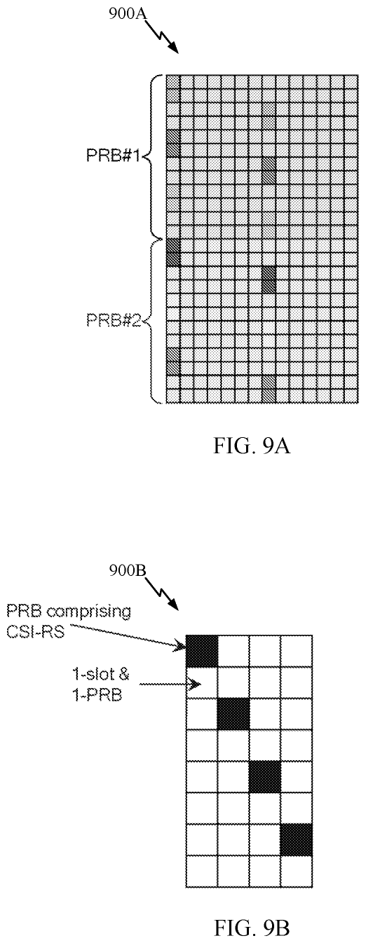

FIGS. 9A-9B illustrate an example of CSI-RS patterns for CSI-RS resource repetition in which CSI-RS resources are staggered across repetitions. As illustrated in example 900A, a number of CSI-RS resources may be spread across multiple PRBs (similar to the example illustrated in FIG. 8A). In each CSI-RS resource repetition, however, a resource element or resource block offset for the CSI-RS resources can be configured such that the CSI-RS resources for a given CSI-RS port are transmitted using different frequency resources for each repetition. Similarly, as illustrated in example 900B, inter-slot repetitions may also be defined in terms of a PRB offset such that CSI-RS repetitions are transmitted in different PRBs in the time domain. Generally, by staggering a CSI-RS repetition pattern across CSI-RS resource repetition instances, aspects described herein can compensate for time domain losses introduced by a reduced density of CSI-RS transmissions from spreading CSI-RS resources at a given time out in the frequency domain across different PRBs.

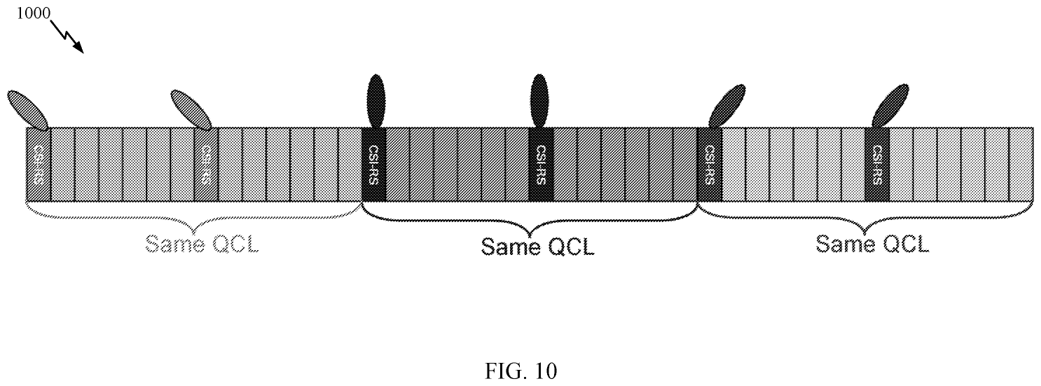

FIG. 10 illustrates an example CSI-RS pattern 1000 in which same or different quasi-colocation (QCL) references may be assumed for different CSI-RS repetitions. Generally, repeated CSI-RS resources may, but need not, be associated with a same QCL reference (e.g., a same QCL Type-A/B/C/D reference). A subset of CSI-RS resource repetitions may be configured to be associated with a same QCL reference, and different subsets of CSI-RS resource repetitions may be configured to be associated with different QCL references.

For a CSI report associated with repeated CSI-RS resources, an associated CSI reference resource may be defined and used by the UE to calculate CSI (e.g., to calculate or otherwise determine a rank indicator (RI), precoding matrix indicator (PMI), and/or channel quality indicator (CQI). The CSI reference resource may be defined in relation to a frequency domain resource assignment or a time domain resource assignment for the CSI-RS repetitions. CSI-RS resources may be defined, for example, in relation to the slot or symbol in which the CSI-RS reference resource is carried. For example, the CSI-RS repetitions from which a CSI report is generated may be defined as the repetitions that are scheduled no later than a last slot or symbol of the CSI reference resource or the repetitions that are scheduled no later than a first slot or symbol of the CSI reference resource.

In some aspects, when calculating CQI, symbols overlapping with and after a first CSI-RS resource repetition and before a next CSI-RS resource associated with a different QCL reference may be assumed to use the same precoding as the precoding measured in the symbols associated with the first CSI-RS repetition.

In some aspects, a UE may refrain from reporting CSI for a specific symbol of a CSI-RS resource. For example, the UE may refrain from reporting CSI for these symbols due to overlaps between the CSI-RS resource and uplink symbols, synchronization signal blocks, resources associated with a control resource set (CORESET), etc. In some aspects, a channel quality indicator (CQI) calculation may assume that resources after the symbol for which the UE refrained from reporting CSI are not included in the calculation. In some aspects, the CQI calculation may be performed based on an assumption that resources after the symbol for which the UE refrained from reporting CSI are associated with a previous CSI-RS for which the UE did not refrain from reporting CSI, if applicable. In some aspects, when a UE refrains from reporting CSI for a specific symbol of a CSI-RS resource, the UE need not generate a CSI report.

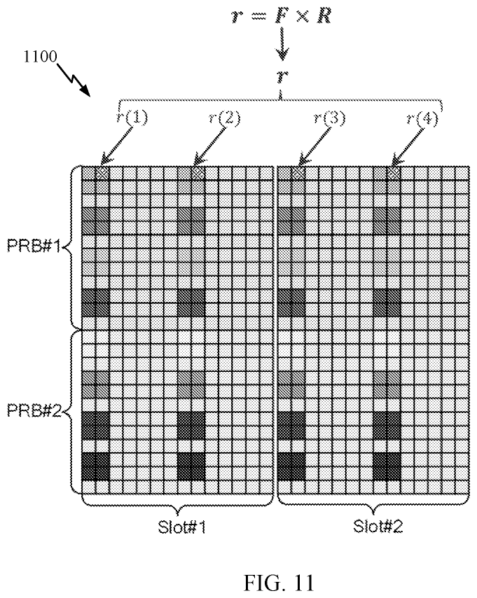

FIG. 11 illustrates an example CSI-RS repetition pattern 1100 in which CSI-RS repetitions are configured as a sequence of CSI-RSs in a transfer domain. As illustrated, a UE may be configured with a CSI-RS sequence R(m) in a transfer domain, such as the sequence

$$R ( m ) = \frac{1}{\sqrt{2}} ( 1 - 2 C ( 2 m ) ) + j \frac{1}{\sqrt{2}} ( 1 - 2 C ( 2 m + 1 ) ) ,$$

1≤m≤M in the Doppler domain.

CSI-RS patterns repeated in the time domain may be configured such that the CSI-RS pattern comprises CSI-RS sequences with time domain spreading. REs in the same location of the same CSI-RS component in different time domain resource assignment instances may be formed into a time domain sequence r(n), 1≤n≤N, and the time domain sequence may be generated by spreading the transfer domain CSI-RS sequence into the time domain. N may represent the number of repeated CSI-RS components in the time domain. In some aspects, the transfer domain may be a discrete Fourier transform (DFT)-basis domain.

In some aspects, the spreading may be performed as a linear operation, such as an inverse DFT operation. For example, the spreading can be performed according to the equation r=F×R, where r and R are the vectors formed by the time domain sequence r(n) and transfer domain sequence R(m), respectively, and F is an N×M matrix comprised by rows of DFT bases. The spreading may be an underdetermined spreading in which N<M, a determined spreading in which N=M, or an overdetermined spreading in which N>M. Generally an underdetermined spreading may allow for further reductions in tie domain resources for measuring Doppler spreads by using a precoding with higher spectral efficiency than the repetition codes.

In some aspects, when time domain spreading for CSI-RS resources is considered, when calculating CQI, the associated CSI reference resource may also be assumed to use time domain spreading techniques for PDSCH transmission. Modulated symbols may be defined in a transfer domain and spread into the time domain. Similar QCL reference assumptions may be used as those described above. Generally, if a transmission of a symbol of a CSI-RS resource is refrained (e.g., due to an overlap with an uplink symbol, an SSB, or symbols in a CORESET), the UE may refrain from generating and transmitting a CSI report.

In some aspects, time restrictions for channel measurements may be adjusted to account for CSI-RS resource repetition. If a CSI-RS resource repetition-based CSI report in which RI/PMI/CQI is used, a UE configured with the higher layer parameter timeRestrictionForChannelMeasurements in a CSI report configuration can derive channel measurements for computing CSI based on a most recent occasion of a non-zero-power (NZP) CSI-RS no later than the CSI reference resources identified by the parameter CSI-RS-ResourceSet associated with the CSI report.

The techniques described herein may be used for various wireless communication technologies, such as NR (for example, 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, or 5G wireless technologies, aspects of the present disclosure can be applied in other generation-based communication systems.

In 3GPP, the term “cell” can refer to a coverage area of a Node B (NB) or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, or other types of cells. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having an association with the femto cell (for example, UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (for example, a smart ring, a smart bracelet, etc.), an entertainment device (for example, a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, which may be narrowband IoT (NB-IoT) devices.

Some wireless networks (for example, LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (for example, 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (for example, 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (for example, a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (for example, one or more other UEs), and the other UEs may utilize the resources scheduled by the UE for wireless communication. In some examples, a UE may function as a scheduling entity in a peer-to-peer (P2P) network, or in a mesh network. In a mesh network example, UEs may communicate directly with one another in addition to communicating with a scheduling entity.

As used herein, the term “determining” may encompass one or more of a wide variety of actions. For example, “determining” may include calculating, computing, processing, deriving, investigating, looking up (for example, looking up in a table, a database or another data structure), assuming and the like. Also, “determining” may include receiving (for example, receiving information), accessing (for example, accessing data in a memory) and the like. Also, “determining” may include resolving, selecting, choosing, establishing and the like.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communications by a user equipment (UE), comprising:
receiving, from a network entity, a configuration identifying channel state information (CSI) reference signal (RS) (CSI-RS) repetitions over which a CSI report is to be generated;
receiving CSI-RS repetitions according to the configuration;
measuring CSI based on the received CSI-RS repetitions; and
transmitting the CSI report including the measured CSI to the network entity.

2. The method of claim 1, wherein the CSI-RS repetitions comprise a plurality of intra-slot or inter-slot repetitions.

3. The method of claim 2, further comprising:
receiving, from the network entity, signaling activating measurements based on the plurality of intra-slot repetitions, wherein the signaling comprises a CSI resource set configured with repetition enabled and tracking reference signal (TRS) information enabled.

4. The method of claim 3, wherein the signaling does not indicate a restriction on a CSI-RS pattern.

5. The method of claim 3, wherein measuring CSI based on the received CSI-RS repetitions comprises measuring CSI based on an assumption that at least two CSI-RS repetitions are associated with different quasi-colocation (QCL) references.

6. The method of claim 1, wherein:
a CSI resource set associated with the CSI-RS repetitions includes a periodicity parameter,
the CSI resource set is associated with a CSI reporting configuration, and
the CSI reporting configuration includes a time restriction for measuring CSI.

7. The method of claim 1, wherein the CSI-RS repetitions comprise a number of CSI-RS ports spanning frequency resources across multiple physical resource blocks (PRBs).

8. The method of claim 1, wherein the CSI-RS repetitions are based on a number of physical resource block (PRB)-level combs.

9. The method of claim 1, wherein the CSI-RS repetitions comprise a staggered CSI-RS pattern across repetitions such that a first CSI-RS repetition is carried on a first frequency resource and a second CSI-RS repetition is carried on a second frequency resource.

10. The method of claim 1, wherein the UE assumes a same quasi-colocation (QCL) for a plurality of the CSI-RS repetitions.

11. The method of claim 1, wherein the configuration identifies a quasi-colocation (QCL) type for each CSI-RS repetition such that a subset of the CSI-RS repetitions are associated with the same QCL type.

12. The method of claim 1, wherein the report is generated based on a CSI reference resource defined for the CSI-RS repetitions.

13. The method of claim 12, wherein the CSI reference resource is defined in relation to a frequency domain resource assignment or a time domain resource assignment for the CSI-RS repetitions.

14. The method of claim 12, wherein the CSI-RS repetitions comprise repetitions that are scheduled no later than a last slot or symbol of the CSI reference resource.

15. The method of claim 12, wherein the CSI-RS repetitions comprise repetitions that are scheduled no later than a first slot or symbol of the CSI reference resource.

16. The method of claim 12, wherein measuring CSI based on the CSI-RS repetitions comprises assuming that symbols overlapping with an after a first CSI-RS repetition and before a next CSI-RS repetition comprises a same precoding as a precoding measured in symbols associated with the first CSI-RS repetition.

17. The method of claim 1, wherein measuring CSI based on the CSI-RS repetitions comprises refraining from reporting CSI for a CSI-report comprising CSI-RS repetitions associated with at least one CSI-RS that overlap with an uplink symbol, a synchronization signal block, or a control resource set.

18. The method of claim 17, wherein measuring CSI based on the CSI-RS repetitions further comprises calculating CQI assuming refraining from using the symbols after CSI-RSs that overlap with an uplink symbol, a synchronization signal block, or a control resource set.

19. The method of claim 17, wherein measuring CSI based on the CSI-RS repetitions further comprises calculating CQI assuming symbols after CSI-RSs that overlap with an uplink symbol, a synchronization signal block, or a control resource set that are associated with other CSI-RSs for which a measurement has been performed.

20. The method of claim 1, wherein the CSI-RS repetitions are configured as a sequence of CSI-RSs in a transfer domain.

21. The method of claim 20, wherein resource elements for a CSI-RS component in different time domain resource assignment instances are formed into a time domain sequence by spreading the sequence of CSI-RSs in the transfer domain into time domain.

22. The method of claim 20, wherein spreading the sequence of CSI-RSs in the transfer domain into time domain comprises spreading the sequence of CSI-RSs in the transfer domain using a linear operation.

23. The method of claim 22, wherein spreading the sequence of CSI-RSs in the transfer domain is performed based on one of an underdetermined operation, a determined operation, or an overdetermined operation with respect to a number of rows corresponding to discrete Fourier transform (DFT) bases.

24. The method of claim 20, wherein the transfer domain comprises a discrete Fourier transform (DFT)-basis domain.

25. The method of claim 20, wherein the sequence of CSI-RSs comprise CSI-RS sequences with time domain spreading.

26. The method of claim 20, wherein measuring CSI based on the CSI-RS repetitions comprises calculating a channel quality indicator from a CSI-RS assuming time domain spreading for a physical downlink shared channel (PDSCH) transmission.

27. The method of claim 1, wherein measuring CSI based on the CSI-RS repetitions comprises deriving channel measurements for CSI reported in an uplink slot based on a latest occasion of a non-zero-power (NZP) CSI-RS prior to CSI reference resources identified in a CSI-RS resource set associated with the CSI report, if the configuration includes a time restriction.

28. A method for wireless communications by a network entity, comprising:
transmitting, to a user equipment (UE), a configuration identifying channel state information (CSI) reference signal (RS) (CSIRS) repetitions over which a CSI report is to be generated;
transmitting CSI-RS repetitions according to the configuration;
receiving a CSI report from the UE based on the transmitted CSI-RS repetitions;
determining one or more parameters for communicating with the UE based on the received CSI report; and
transmitting the determined parameters to the UE.

29. The method of claim 28, wherein the CSI-RS repetitions comprise a plurality of intra-slot or inter-slot repetitions.

30. The method of claim 29, further comprising:
transmitting, to the UE, signaling activating measurements based on the plurality of intra-slot repetitions, wherein the signaling comprises a CSI resource set configured with repetition enabled and tracking reference signal (TRS) information enabled.

31.-44. (canceled)
